(19) United States
(12) Patent Application Publication
(10) Pub. No.: US 2026/0034480 A1
(43) Pub. Date: Feb. 5, 2026

(54) FLUID REMOVAL DEVICE

(71) Applicant: Civ-Con Products & Solutions LLC, Lakeway, TX (US)

(72) Inventor: Judd Clayton Cashatt, Lakeway, TX (US)

(73) Assignee: Civ-Con Products & Solutions LLC, Lakeway, TX (US)

(21) Appl. No.: 19/283,886

(22) Filed: Jul. 29, 2025

Related U.S. Application Data
(60) Provisional application No. 63/677,250, filed on Jul. 30, 2024.

(51) Int. Cl. B01D 21/30; B01D 21/01; E03F 5/10

(52) U.S. Cl. CPC B01D 21/307; B01D 21/01; E03F 5/103

(57) ABSTRACT

An apparatus that may include base section further comprising one or more tubulars and a siphon formed from the one or more tubulars. The apparatus may further include a swivel section fluidly connected to the base section and further comprising an orifice plate and a floating section fluidly connected to the swivel section in which a fluid may enter.

### CROSS REFERENCE TO RELATED APPLICATIONS

This application claims the priority of U.S. Provisional Patent Application No. 63/677,250, filed Jul. 30, 2024, which is incorporated by reference in its entirety.

### BACKGROUND

This invention relates to a variable flow surface water outlet device of the type used to allow water to be drained from sediment ponds or basins, in order to capture sediment or prevent overflow and flooding of surrounding areas. These devices are sometimes referred to as “skimmers.” Sediment ponds are frequently used to prevent or minimize water runoff from agricultural land and construction sites where rain or other water sources may erode and wash large amounts of sediment onto neighboring property, waterways, and other areas if not controlled. Sediment has a particularly detrimental effect on drinking water supplies and can substantially reduce the volume of water that can be stored in rivers and impoundments used to supply municipal water systems.

Sediment ponds are constructed according to regulations and typically include temporary soil embankments raised above the surrounding land forming the impoundment. Many regulations now require sediment ponds to be equipped with a flotation device that drains water from the pond at a controlled rate when the water reaches a specified level. The device is intended to drain water from the very top surface at a controlled rate, resulting in the clearest possible discharge, while the sediment remains on the bottom of the pond or basin. However, current skimmers typically provide an inlet orifice fixed near the surface of the water. Since the orifice size and head pressure are constant or nearly constant, the flow through the skimmer is also nearly constant regardless of the elevation of the water in the sediment pond. During smaller and more frequent storm events, this creates unnecessarily high discharge of more turbid waters found the lower elevations of the basin, needlessly polluting downstream property and waterways. There exists a need to provide better water quality while maintaining total volume discharge.

### BRIEF DESCRIPTION OF THE DRAWINGS

These drawings illustrate certain aspects of some of the embodiments of the present invention and should not be used to limit or define the invention.

FIG. 1 illustrates a fluid removal device disposed in a retention area.

FIG. 2 illustrates a breakout view of the fluid removal device.

FIGS. 3A and 3B illustrate a breakout view of an orifice plate.

FIGS. 4A and 4B illustrate different skimmer embodiments.

FIG. 5 illustrates another embodiment of the fluid removal device.

FIGS. 6A-6C illustrate possible designs that may be disposed within the surface of a downtube.

FIG. 7 illustrates an example of a floc injector.

FIG. 8 illustrates the fluid removal device with a singular floating section and siphon.

FIG. 9 illustrates a hinge valve.

FIG. 10 illustrates the hinge valve in an exploded view from a back perspective of the hinge valve.

FIG. 11 illustrates a view of a fluid outlet disposed in a slit.

FIG. 12 illustrates the hinge valve in an exploded view from a front perspective of hinge valve.

FIGS. 13 and 14 illustrate a variable flow plate that controls the fluid flow through the hinge valve.

FIG. 15 illustrates an exploded view of a skimmer.

FIG. 16 illustrates the floc injector disposed in a downtube.

FIG. 17 illustrates a cross pipe disposed within the skimmer.

FIG. 18 illustrates an example in which the skimmer may be floating at an elevated position above variable flow apparatus.

FIG. 19 illustrates a perspective view of the skimmer.

FIGS. 20 and 21 illustrate another example of the skimmer.

### DETAILED DESCRIPTION

Disclosed herein is a variable flow apparatus for use in sediment ponds. The methods and systems described below may be utilized to restrict flow at lower, more turbid pond elevations to increase sediment and pollutant capture during the majority of small-to-medium sized storm events but also provide substantially higher flow at the highest pond elevations, providing a timely discharge of larger volumes created by infrequent, larger storm events.

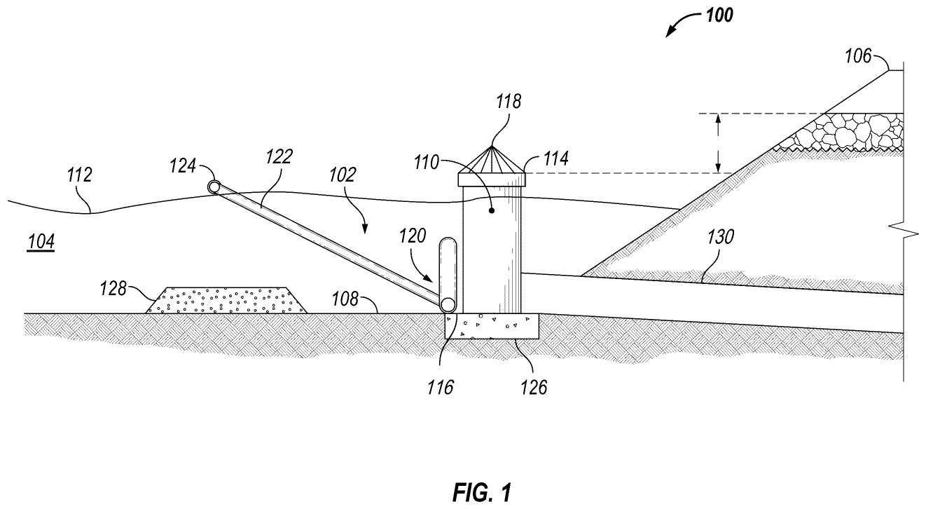

FIG. 1 illustrates a retention area 100 in which a fluid removal device 102 is disposed to remove fluid 104 at a set rate within retention area 100. Retention area 100 may comprise one or more berms 106 that may be scaled to hold an engineered amount of fluid from retention area 100. In examples, retention area 100 may be located in the lower elevations along the perimeter or within the interior of one or more drainage areas of a construction project or developed construction site. Each of the one or more berms 106 may enclose an engineered and/or selected area to form a bottom 108 of retention area 100. In examples, bottom 108 may be covered with a filter fabric and/or vertical baffles to reduce the rate of fluid flow across retention area 100, which may allow for sediment disposed within fluid 104 to settle to bottom 108. As illustrated, fluid removal device 102 may be fluidly connected to riser structure 110. In examples, riser structure 110 may function and/or operate as an outlet in which fluid 104 may be removed from retention area 100. As illustrated, riser structure 110 may extend vertically out of fluid 104 above surface layer 112. In such examples, fluid 104 may be removed from retention area 100 through fluid removal device 102, discussed below. However, in examples in which a large amount of fluid enters retention area 100, surface layer 112 may rise over top 114 of riser structure 110. Fluid 104 that rises over top 114 of riser structure 110 and may fall into riser structure 110. Fluid 104 may then be removed through relief pipe 130. It should be noted that fluid removal device 102 may connect directly to riser structure 110 through fluid outlet 116. Large debris within fluid 104 may be prevented from moving into riser structure 110, which may clog riser structure 110, with debris shield 118.

As noted above, fluid 104 may flow through fluid removal device 102 or through riser structure 110 and to relief pipe 130. Although fluid removal device 102 is illustrated disposed at the bottom of retention area 100, fluid removal device 102 may be disposed at any location within retention area 100 and may be perched on any structure. Thus, fluid removal device 102 may be designed to be any distance below surface layer 112 of fluid 104. Fluid removal device 102 may control the rate at which fluid 104 may be removed from retention area 100. Fluid removal device 102 may comprise a variable flow apparatus 120, which may attach to riser structure 110 through fluid outlet 116, at one end, as well as attach to downtube 122 at an end opposite fluid outlet 116. Downtube 122 may connect to variable flow apparatus 120 at one end and skimmer 124 at the opposing end of downtube 122. It should be noted that downtube 122 may be tubular but may be any suitable shape, such as square, rectangular, polynomial, and/or the like. Fluid removal device 102 is discussed below in greater detail.

As illustrated in FIG. 1, at least a part of fluid removal device 102 may float on surface layer 112. While floating on surface layer 112, a set amount of fluid 104 may enter fluid removal device 102, which then may be removed through riser structure 110 and relief pipe 130 using gravity. In order to operate effectively both fluid removal device 102 and riser structure 110 may be disposed on a foundation 126. Foundation 126 may be a structure, such as concrete, that forms a solid base for the operation and function of riser structure 110 and fluid removal device 102. During operations, as surface layer 112 goes down, due to the removal of fluid 104 at a pre-determined rate using fluid removal device 102, at least a part of fluid removal device may also continue to float on surface layer 112 and move toward bottom 108. As at least a part of fluid removal device 102 moves toward bottom 108, at least a part of fluid removal device may come into contact with a rest structure 128. Rest structure 128 may be a build-up of material such as stone, pebbles, rocks, and/or the like. In other examples, rest structure 128 may be a man-made structure disposed on bottom 108.

Fluid removal device 102 may operate and function according to the systems and methods disclosed below. Smaller sediment particles within fluid 104 require more time to settle than larger particles thereby creating more turbid water in the lower elevations of fluid 104. Generally, fluid removal device 102 may be designed to remove fluid 104 from retention area 100 at any variable rate designed by a user to allow for increased time for sediment within fluid 104 to settle toward bottom 108. For example, when a retention area 100 fills with fluid 102 at a slower rate or to particular holding capacity such as about twenty-five percent, fluid removal device 102 may be designed to allow fluid 104 to be removed at a slower flow rate and over a longer period of time in order to capture sediment within the retention area 100. However, if fluid 104 rises rapidly or to a larger holding capacity of retention area 100, such as about seventy five percent, variable flow rates allowed by fluid removal device 102, as discussed below, may be increased to quickly remove fluid 104 from retention area 100. As the holding capacity lowers due to the removal of fluid 104 through fluid removal device 102, such as from one hundred percent to thirty percent, variable rates allowed by fluid removal device 102 may decrease to provide more time for smaller sediment particles within the lower elevations of fluid 104 to settle toward bottom 108.

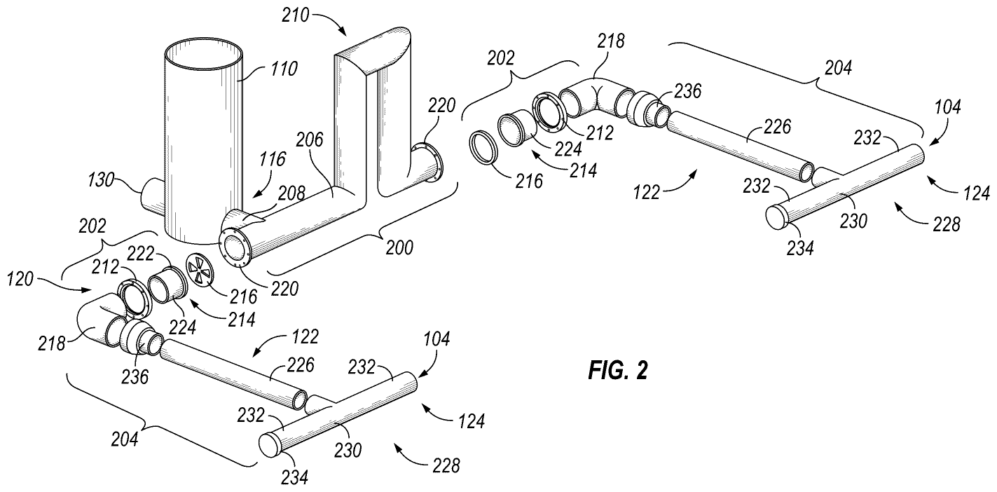

FIG. 2 illustrates fluid removal device 102 that may be fluidly connected to riser structure 110. As noted above, fluid removal device 102 may comprise variable flow apparatus 120, downtube 122, and/or skimmer 124. As illustrated, variable flow apparatus 120 may connect to riser structure 110, which may be connected to fluid outlet 116, which may operate and function as described above. For this disclosure, variable flow apparatus 120 may be broken into base section 200, swivel section 202, and/or floating section 204. Base section 200 may comprise of one or more tubulars 206 of any inner dimension and/or outer dimension. Further, tubulars 206 may be any suitable material such as metal and/or plastic. In examples, base section 200 may be fluidly connected to riser structure 110 by fluid outlet 208. Fluid outlet 208 may connect to at least a portion of base section 200 at any suitable location. During operations, fluid 104 (e.g., referring to FIG. 1), may traverse through floating section 204, through swivel section 202, through base section 200, through fluid outlet 208 and into riser structure 110. Fluid 104 may then be removed through fluid removal device 102 using the methods and systems described above. With continued reference to base section 200, base section 200 may further comprise one or more siphons 210. Siphon 210 may comprise one or more tubulars 206 that may be fluidly connected to tubulars 206 of base section 200. In examples, siphon 210 may function and operate to form suction within base section 200. Suction may be created by siphon 210 when surface layer 112 rises high enough to trap air created by the tubulars 206 within siphon 210. Siphon 210 is configured to charge or prime at a minimum height corresponding to the height of surface layer 112. Generally, siphon 210 may be utilized when one or more floating sections 204, discussed below, may be utilized within retention area 100 (e.g., referring to FIG. 1). In examples, siphon 210, while applying suction, may be engineered to activate at least one floating section 204 based at least in part on surface layer 112 (e.g., referring to FIG. 1). As noted above, each floating section 204 may float on surface layer 112 based at least in part on swivel section 200.

Swivel section 202 may comprise one or more components that may allow floating section 204 to move vertically relative to based section 200. As illustrated, swivel section 202 may comprise a connecting flange 212, a flanged sleeve 214, an orifice plate 216, and an elbow 218. As illustrated, flanged sleeve 214 may traverse through connecting flange 212. Orifice plate 216 may then rest upon flange 222 of flanged sleeve 214. Connecting flange 212 may then be attached to receiving flange 220. Receiving flange 220 may be a part of based section 200 and/or connected to base section 200. In examples, when connecting flange 212 and receiving flange 220 may be connected, flanged sleeve 214 and/or orifice plate 216 may be disposed between them and form a seal. During operations, flanged sleeve 214 may rotate between connecting flange 212 and receiving flange 220. This rotation may be utilized to change the flow of fluid 104 through orifice plate 216 by altering the open area and/or shape of orifice plate 216. Also, during operation, since the elevation of the orifice plate 216 remains fixed near the bottom 108, surface layer 112 may be utilized to change the flow of fluid 104 by increasing or decreasing the head pressure placed on orifice plate 216.

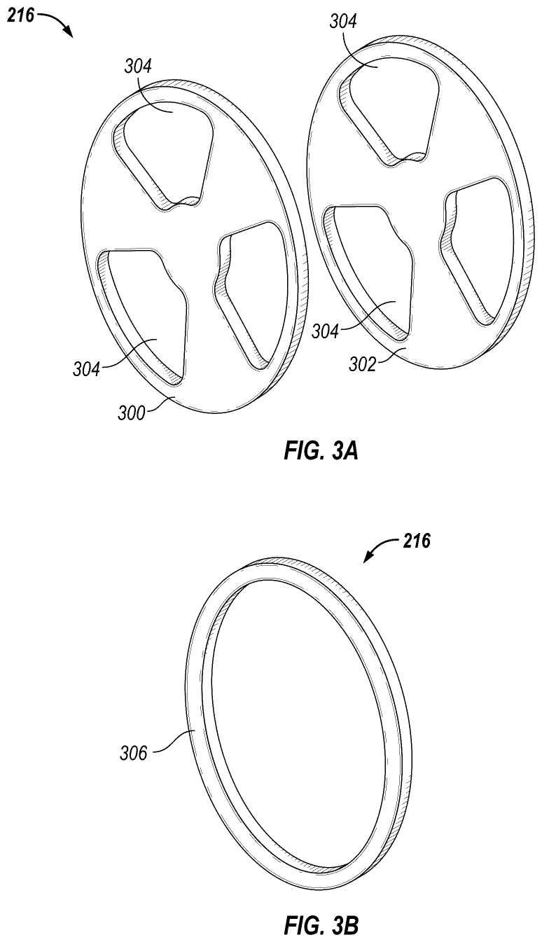

FIGS. 3A and 3B illustrate different embodiments of orifice plate 216. FIG. 3A illustrates an embodiment in which orifice plate 216 may further comprise a swivel plate 300 fluidly and operably connected to fixed plate 302 to allow for axial rotation of swivel plate 300 relative to the fixed plate 302. Swivel plate 300 and fixed plate 302 may be disposed between receiving flange 220 and connecting flange 212 or may be fluidly connected to siphon 210 via a receiving flange 220 (e.g., referring to FIG. 2). Swivel plate 300 and fixed plate 302 may each comprise one or more apertures 304 of varying size and shape. Apertures 304 on swivel plate 300 and fixed plate 302 may be identical in at least one orientation to allow for peak manufactured flow. In another orientation the apertures 304 on plates 300 and 302 may not have any overlap to allow for about no flow. Swivel plate 300 may be further fluidly connected to floating section 204 connecting flange 212 and elbow 218. Fixed plate 302 may be fluidly connected to a riser structure 110 via receiving flange 220. The floating section 204 is operable to move vertically relative to based section 200 depending on surface layer 112. When surface layer 112 changes floating section 204 may move vertically relative to based section 200. When floating section 204 moves vertically swivel plate 300, which is fixed to an elbow 218 affixed to the floating section 204 (e.g., referring to FIG. 2), may be rotated axially relative to fixed plate 302. When floating section 204 moves vertically the one or more apertures 304 on swivel plate 300 may entirely overlap, variably overlap, or not overlap with the apertures 304 on fixed plate 302. The variable overlap of the apertures 304 may vary flow rate as fluid 104 may traverse through apertures 304 to flow between plates 300 and 302. When assembled in swivel section 202, orifice plate 216 may be configured to allow for manufactured flow of fluid 104 at the max height of floating section 204 and may be configured to partially or fully restrict flow of fluid 104 at the minimum height of floating section 204.

FIG. 3B illustrates orifice plate 216 which may consist of a constant orifice 306. Constant orifice 306 may be of any size and may be round (as illustrated), triangular, hexagonal, trapezoidal or any other shape to manufacture flow of fluid 104 through fluid removal device 102. Orifice plate 216 may be disposed between receiving flange 220 and connecting flange 212. Orifice plate 216 may be fluidly connected to siphon 210 via a receiving flange 220 (e.g., referring to FIG. 2). The orifice plate 216 may be fluidly connected to a floating section 204 via connecting flange 212 and may be operable to allow vertical movement of the floating section 204 relative to base section 200 depending on surface layer 112 (e.g., referring to FIGS. 1 and 2). Orifice plate 216 may comprise one or more apertures 304 of varying size and shape. Fluid 104 may traverse through apertures 304. The flow of fluid 104 may depend on head pressure created by the surface layer 112 relative to the base section 200 and orifice plate 306. The flow of fluid 104 may also depend on suction pressure through siphon 210 and also surface layer 112 relative to siphon 210 and orifice plate 306.

Referring back to FIG. 2, flanged sleeve 214, as described above may traverse through connecting flange 212 and at least in part protrude. Sleeve 224, which may be connected to flange 222 may act as a mating surface upon which elbow 218 may seat. Elbow 218 may be utilized to connect swivel section 202 to floating section 204.

As illustrated in FIG. 2, downtube 122 may comprise a tubular arm 226, which may connect elbow 218 to inlet 228. In examples, tubular arm 226 may be flexible and not ridged, as illustrated in FIG. 2. Further, in embodiments tubular arm 226 may be at least partially flexible and partially rigid. Additionally, tubular arm 226 may comprise two or more pieces, wherein at least one of the pieces may be flexible. In other embodiments each of the two or more pieces may be ridged. It should be noted that tubular arm 226 may have the same dimensions as elbow 218. However, in other examples, tubular arm 226 may be a different dimension than elbow 218. A reducer 236 (or expander) may be utilized to connect elbow 218 to tubular arm 226. The length of tubular arm 226 may be chosen based on the engineered surface layer 112 (e.g., referring to FIG. 1) for retention area 100 (e.g., referring to FIG. 1). Tubular arm 226 may be fluidly connected to inlet 228 by any suitable means, such as a T-junction 230. T-junction 230 may further be fluidly connected to skimmer 124. Skimmer 124 may comprise inlet arms 232 that may increase the open area upon which fluid 104 (e.g., referring to FIG. 1), may enter inlet 228. As illustrated, at least one or both ends of inlet arms 232 may be capped by end cap 234.

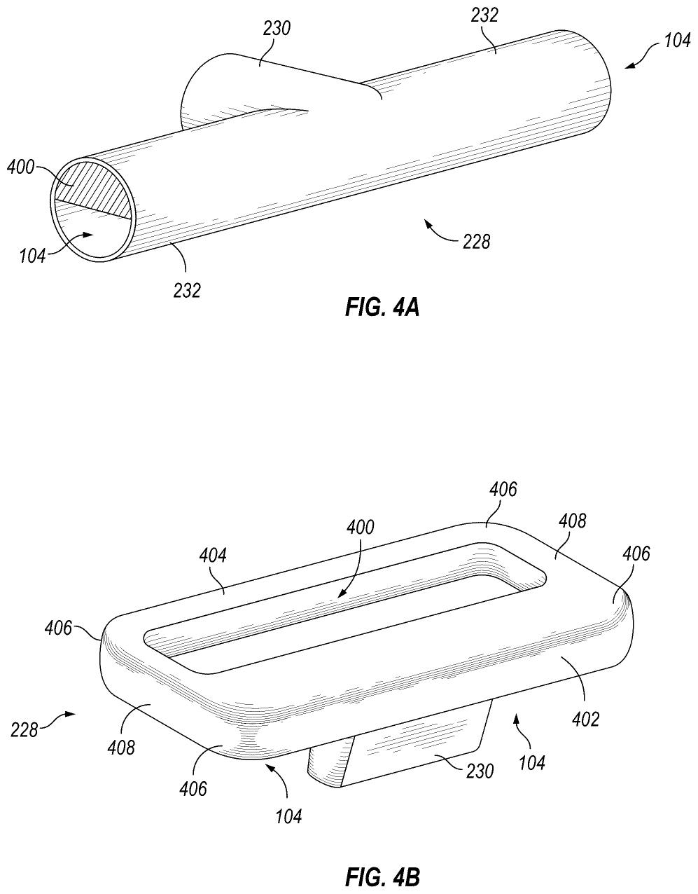

FIGS. 4A and 4B illustrate different types of skimmers 124. With reference to FIG. 4A, inlet 4A is also represented in FIG. 2. As noted above, inlet arms 232 may be capped or not capped by end cap 234 (e.g., referring to FIG. 2. In this example, fluid 104 may enter through inlet arms 232, which are not capped.) Within inlet arms 232 and T-junction 230 at least a part of inlet arms 232 and T-junction 230 may comprise flotation material 400, such as air or foam. Flotation material 400 may allow for inlet 228 to float on surface layer 112 (e.g., referring to FIG. 1). In other examples, at least one or both ends of inlet arms 232 may be open to receive fluid 104. Inlet 228 may have any number of configurations to allow fluid 104 to enter fluid removal device 102. Although not shown, in other examples, fluid 104 may enter inlet 228 through one or more slots, holes, and/or any other removed section within inlet 228. FIG. 4B illustrates inlet 228 with a first flotation arm 402 and a second flotation arm 404 that may be about parallel to each other. First flotation arm 402 and second flotation arm 404 may be tubulars that may be connected to each other by any number of elbows 406 and/or any number of tubular extensions 408. As described in FIG. 4A, all or at least a part of the inside of first flotation arm 402, second flotation arm 404, elbows 406, and/or tubular extensions 408 may be filed with flotation material 400. Although not illustrated, fluid 104 may enter inlet 228 through one or more slots, holes, and/or any other removed section within inlet 228. Inlet 228 in FIG. 4B may also connect to tubular arm 226 (e.g., referring to FIG. 2) through T-junction 230.

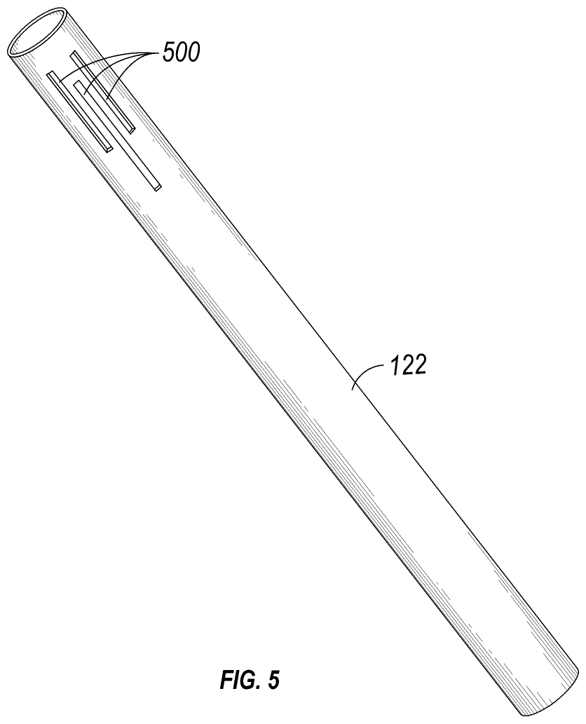

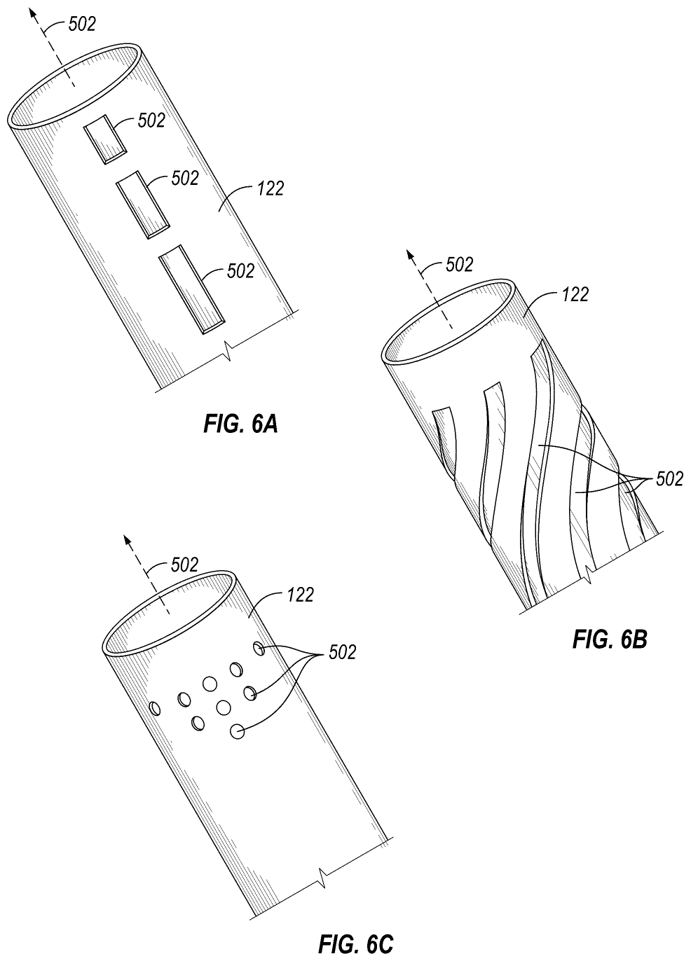

FIG. 5 illustrates an embodiment of downtube 122. As noted above, downtube 122 may connect variable flow device 120 to skimmer 124. Downtube 122 may be any suitable shape, length, width, and/or size. Length, width, and/or shape may be chosen based at least in part on retention area 100 and/or flow of fluid 104 that may be chosen to be removed from retention area 100 through fluid outlet 116. As illustrated in FIGS. 6A-6C, downtube 122 may have one or more apertures 500 disposed through the surface of downtube 122. In examples, apertures 500 may be any shape, such as square, circular, rectangular, polynomial, and/or the like. There may be one aperture 500, multiple apertures 500, and/or each aperture 500 may be different in size, shape, length, and/or the like compared to another aperture 500 disposed on downtube 122. Apertures 500 may be disposed perpendicular, parallel, and/or angled to longitudinal axis 502 of downtube 122. Additionally, apertures 500 may twist about the longitudinal axis 502 in any preferable design. Specifically, the shape, parameters, characteristics, and/or location of apertures 500 may allow for a chosen variable flow of fluid 104, through apertures 500 and into downtube 122.

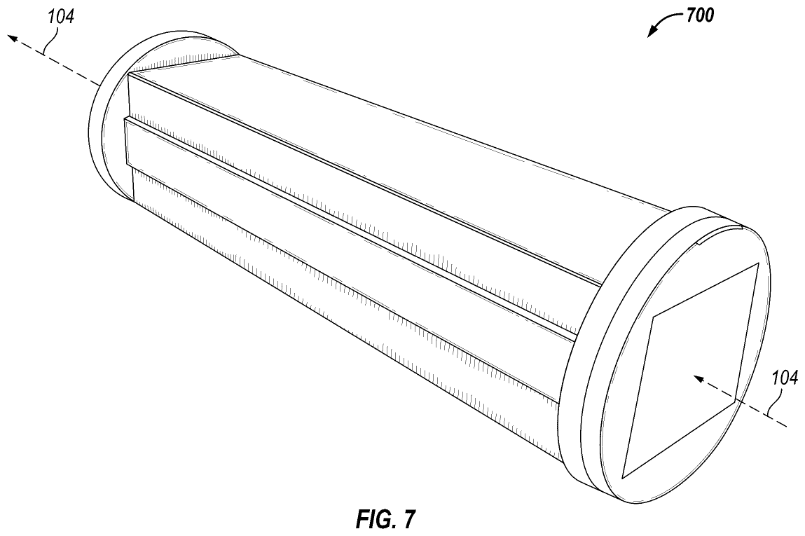

FIG. 7 illustrates an example of a floc injector 700. Floc injector 700 is a device used to introduce flocculant to create flocculation, the process of clumping together small particles in a liquid to form larger, settleable flocs. In examples, floc injector 700 may utilize liquid, powder, or solid chemicals or electricity to create flocculation. The flocculant might be cationic or anionic polymers or proteins of natural or man-made origin. The flocculant might be metered at a certain rate of injection or dissolve into fluid 104 as it passes along or through floc injector 700. Referring to FIG. 2, floc injector 700 may be disposed within floating section 204 at any location along downtube 122. Additionally, floc injector 700 may be disposed in skimmer 124 at any suitable location within inlet 228. Further, floc injector 700 may be disposed adjacent to and/or connected to fluid outlet 208 and any outlet that fluid 104 may flow through from skimmer 124 and/or downtube 122. Referring back to FIG. 7, floc injector 700 may operate and function to introduce flocculant and a controlled rate which may correlate to volume of fluid 104 relative to that of retention area 100 or a variable flow rate of fluid 104 through fluid removal device 102. Additionally, floc injector 700 may introduce a larger quantity of flocculant into fluid 104 during earlier periods of a rainstorm where higher sediment loads are anticipated. Additionally, floc injector 700 may introduce smaller quantities of flocculant into fluid 104 for smaller rainstorms and larger quantities for larger rainstorms.

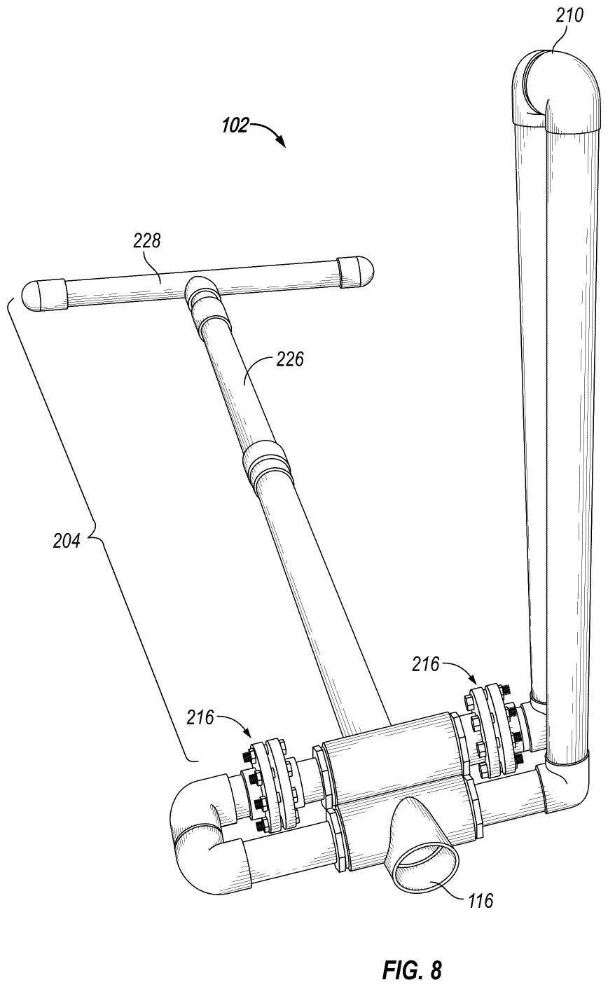

FIG. 8 illustrates a fluid removal device 102 with a singular floating section 204 in accordance with some embodiments of the present disclosure. As illustrated, a singular floating section 204 may be disposed in a location fluidly connected between two orifice plates 216 wherein fluid removal device 102 may be configured to be in a closed loop configuration wherein a flow of fluid 104 traverses a closed loop from inlet 228 to fluid outlet 116 (e.g., referring to FIG. 2). A first orifice plate 216 comprising a swivel plate 300 and fixed plate 302 may be disposed within a swivel section 202, wherein orifice plate 216 may be configured to allow for a variable flow of fluid 104 corresponding to the alignment of apertures 304 on swivel plate 300 and apertures 304 on fixed plate 302 (e.g., referring to FIGS. 1-3). In this manner, first orifice plate 216 may comprise a swivel plate 300 and fixed plate 302 may be configured to allow for an increased flow of fluid 104 at a higher height of floating section 204 relative to based section 200, and configured to allow for a decreased flow of fluid 104 at a lower height of floating section 204 relative to based section 200. A second orifice plate 216 may be disposed within swivel section 202, wherein flow of fluid 104 traverses to siphon 210 prior to flow of fluid 104 traversing to outlet 116. Referring to FIGS. 3A-B, first and second orifice plate 216 may be any combination of apertures 304 and constant orifice 306.

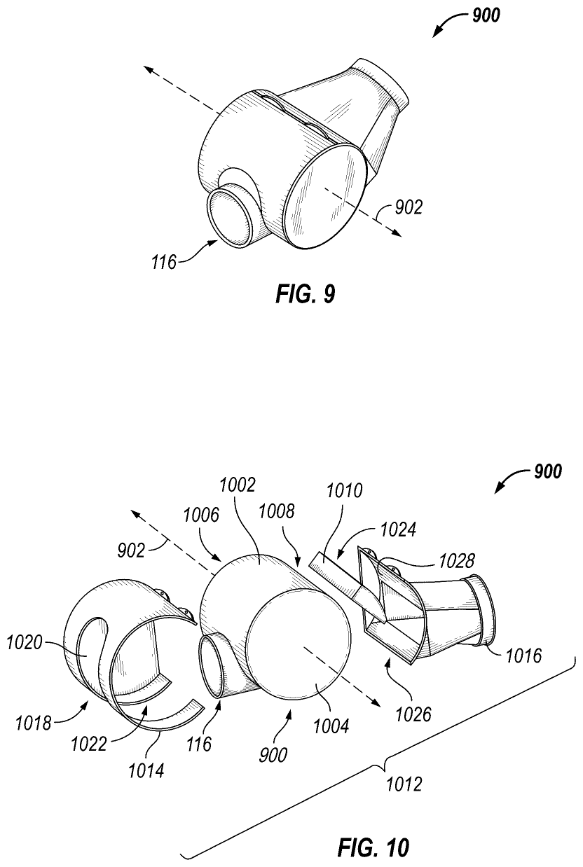

FIGS. 9-14 illustrate an embodiment of variable flow apparatus 120 (e.g., referring to FIG. 1) which is a hinge valve 900. Hinge valve 900 is another embodiment of at least a part of fluid removal device 102. Referring to FIG. 9, hinge valve 900 may pivot around longitudinal axis 902. In examples, hinge valve 900 may connect downtube 122, which is connected to skimmer 124, as discussed above in FIG. 1. During operations, hinge valve 900 may operate and function to have a variable flow of fluid 104 (e.g., referring to FIG. 1) through hinge valve 900 at different locations during rotation of hinge valve 900. The variable flow of fluid 104 through hinge valve 900 may control the amount of fluid 104 moving through fluid outlet 116 to be expelled, per the systems and methods discussed above.

FIG. 10 illustrates hinge valve 900 in an exploded view from a back perspective of hinge valve 900. For example, hinge valve 900 may comprise a cylinder 1002, which may be tubular in construction, in which cylinder 1002 may be closed by a first bulkhead 1004 at one end and a second bulkhead 1006 at the opposite end of cylinder 1002. As illustrated here, fluid outlet 116 may attach to cylinder 1002 at any suitable point along cylinder 1002. In examples, fluid outlet 116 may be centered, off centered, or at any point along the longitudinal axis 902 of cylinder 1002. As discussed below, a slot 1008 may be disposed in the outer surface of cylinder 1002 opposite fluid outlet 116. In examples, slot 1008 may be centered, off centered, or at any point along the longitudinal axis 902 of cylinder 1002. Further discussed below, variable flow plate 1010 may be manufactured to fit within slot 1008. Slot 1008 may comprise a suitable structure, such as a flange, to prevent variable flow plate 1010 from passing through the outer surface of cylinder 1002 and into the area formed by cylinder 1002. An outer rotating structure 1012 may encapsulate at least in part cylinder 1002, first bulkhead 1004, second bulkhead 1006, and/or variable flow plate 1010. As illustrated, outer rotating structure 1012 may comprise a rotational shell 1014 and an inlet shell 1016. During operation, both rotational shell 1014 and inlet shell 1016 may be combined to form outer rotation structure 1012. Outer rotation shell 1014 may partially encapsulate cylinder 1002. A slit 1018 may be formed within rotational shell 1014 in which fluid outlet 116 may pass through. During operation in which rotating structure 1012 rotates, slit 1018 may allow for rotation without contacting fluid outlet 116, which may stop rotation of rotating structure 1012.

FIG. 11 illustrates a view of fluid outlet 116 disposed in slit 1018. As rotational shell 1014 rotates about longitudinal axis 902, slit 1018 allows movement of rotational shell 1014 around cylinder 1002. Thus, fluid outlet 116 is not contacted by slit 1018. In examples, slit 1018 may have any length 1100, which may control the maximum and minimum movement of rotational shell 1014 around cylinder 1002. Further, the width 1102 of slit 1018 may be any width to accommodate fluid outlet 116.

Referring back to FIG. 10, as noted above, rotational shell 1014 is shown in an exploded view, however rotational shell 1014 may have a first plate 1020 at a first end and an open end 1022 at an end opposite the first end of rotational shell 1014. Rotational shell 1014 may attach to inlet shell 1016 using any suitable means. Inlet shell 1016 may be of any size or shape that may allow inlet shell 1016 to attach to downtube 122 (e.g., referring to FIG. 1). Although in embodiments inlet shell 1016 may attach to downtube 122, in other embodiment fluid outlet 116 may attach to downtube 122 and fluid may flow from fluid outlet 116 through hinge valve 900 and out inlet shell 1016. This would be reverse flow of fluid through valve 900 but may still operate and function as intended and described herein. Inlet shell 1016 may be formed to allow any amount of water flow through inlet shell 1016 at any specified rate. For example, orifice 1024 of variable flow plate 1010 may be of any size or shape to determine the amount of fluid flow through inlet shell 1016. As illustrated, orifice 1024 may be rectangular and traverse the width and height of inner surface 1028 of inlet shell 1016. As noted above, however, orifice 1024 may be any shape and/or size in width, height, and/or depth. In this example, throat 1026 changes from a circular opening at the first end of inlet shell 1016 to a rectangular opening at the opposite end. However, the shape of throat 1026 may be the same through inlet shell 1016 or change a plurality of times between first end and second end.

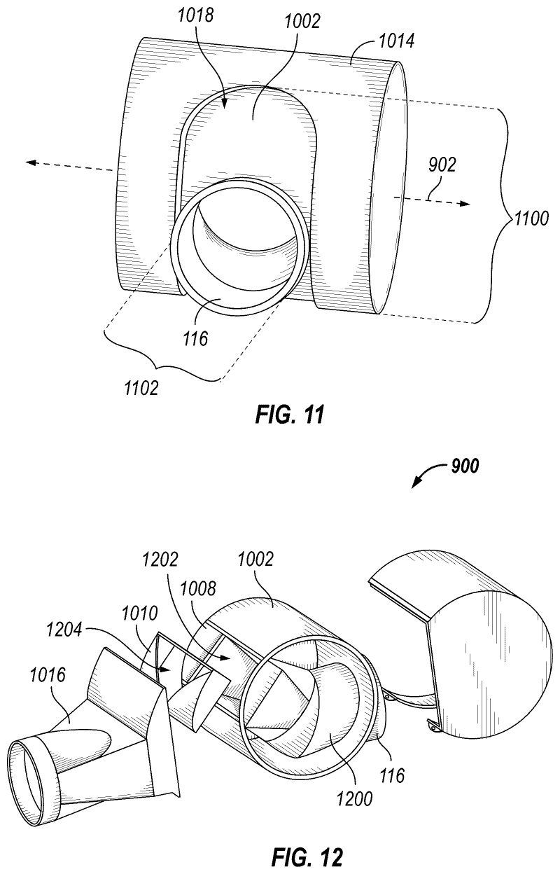

FIG. 12 illustrates hinge valve 900 in an exploded view from a front perspective of hinge valve 900. In this view cylinder 1002 is shown in a cut away view to illustrate channel 1200. Channel 1200 may have a channel inlet 1202 connected to slot 1008. Channel inlet 1202 and slot 1008 may be of any size or shape that may control the fluid flow, such as the rate of fluid movement through channel 1200, from slot 1008 to fluid outlet 116 through channel 1200. As illustrated, channel inlet 1202 may be rectangular and traverse the width and height of at least a portion of an outer surface of cylinder 1002. As noted above, however, channel inlet 1202 may be any shape and/or size in width, height, and/or depth. In this example, channel 1200 changes from a rectangular opening at slot 1008 to a circular opening at fluid outlet 116. However, the shape of channel 1200 may be the same through channel 1200 or change a plurality of times between channel inlet 1202 and fluid outlet 116. As noted above, variable flow plate 1010 may be disposed in slot 1008 and may further control the fluid flow from inlet shell 1016 to fluid outlet 116. As illustrated in FIG. 12, variable flow plate 1010 may further comprise an opening 1204 that traverses through variable flow plate 1010. Opening 1204 may further control the fluid flow rate through hinge valve 900, more specifically, the rate of fluid flow from inlet shell 1016 to channel 1200. As illustrated, opening 1204 may have the shape of a triangle. However, opening 1204 may have any suitable shape, width, or height within variable flow plate 1010.

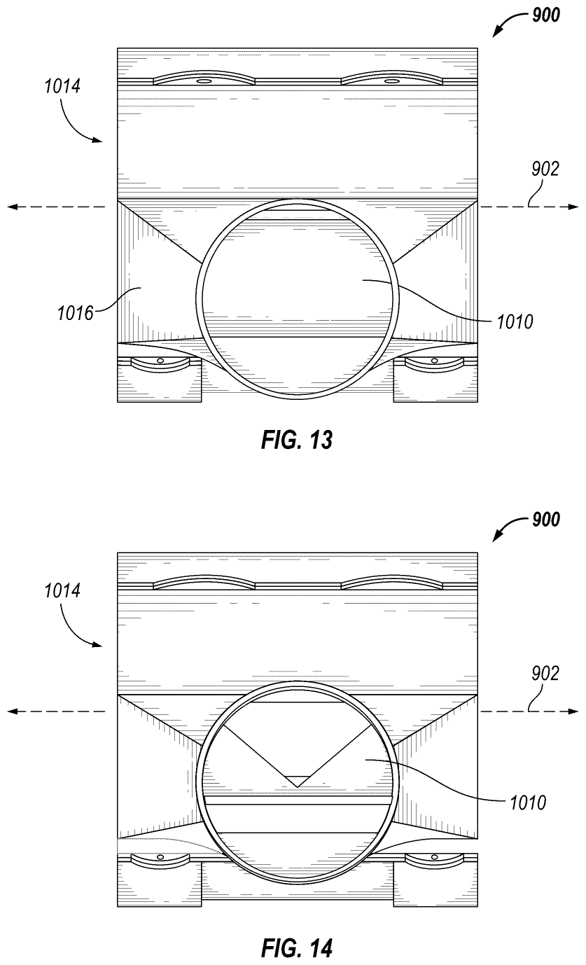

FIGS. 13 and 14 illustrate how variable flow plate 1010 may control fluid flow through hinge valve 900. As noted above rotational shell 1014 may rotate about longitudinal axis 902 of hinge valve 900. Referring to FIG. 13, during use when little to no fluid 104 may be present in an area in which hinge valve 900 may operate and function, rotational shell 1014 may be at or near parallel with bottom 108. This may be referred to as a closed position. In a closed position, as illustrated in FIG. 13, opening 1204 (e.g., referring to FIG. 12) is not viewable through inlet shell 1016. Thus, no fluid 104 may flow through opening 1204 and through hinge valve 900. However, as fluid 104 increases in the area, as described above, and shown in FIG. 1, skimmer 124 may cause downtube 122 to elevate as skimmer 124 floats on surface layer 112 within retention area 100 (e.g., referring to FIG. 1). This elevation may in turn elevate rotation shell 1014, as illustrated in FIG. 14.

FIG. 14 illustrates a rotation of rotational shell 1014 about longitudinal axis 902 may expose opening 1204, which may be seen through inlet shell 1016. The shape, size, width, and/or height of opening 1204 may control the amount of fluid 104 that may flow through hinge valve 900. Thus, variable flow plate 1010 may be constructed in any manner in which to control fluid flow at any rate in which a user desires. Additionally, as variable flow plate 1010 is removable within slot 1008 (e.g., referring to FIG. 12) a user may change variable flow plate 1010 to change the operation and function of hinge valve 900.

Referring to FIGS. 2 & 10, orifice plate 216 and variable flow plate 1010 may operate and function to lower the flow of fluid 104 through downtube 122 to a flow less than the capacity of fluid flow that downtube 122 (e.g., referring to FIG. 7) may be capable of. Lowering the flow rate of fluid 104 may cause fluid 104 to backfill at least in part into downtube 122. It should be noted that in some examples fluid 104 may backfill into skimmer 124 as well (e.g., referring to FIG. 1). The backfill in downtube 122 and/or skimmer 124 may create head pressure within downtube 122 and/or skimmer 124. Head pressure may be variable and may depend on surface layer 112 of fluid 104 in retention area 100 (e.g., referring to FIG. 1). As surface layer 112 increases in height across retention area 100, head pressure may increase. In vice versa, as surface layer 112 decreases in height across retention area 100, head pressure may decrease. In examples, a filled downtube 122 has slower velocity than that of an unfilled downtube 122 with the same fluid flow. Further, a filled downtube 122 has more volume of fluid 104 and surface area contact in downtube 122. Additionally, a filled downtube 122 may provide slower velocities for each variable flow rate and therefore provides for optimum location to meter and mix flocculants, which may be created by floc injector 700, discussed above in FIG. 7. The head pressure created is independent of the variable flow of fluid 104 through variable flow plate 1010 in hinge valve 900.

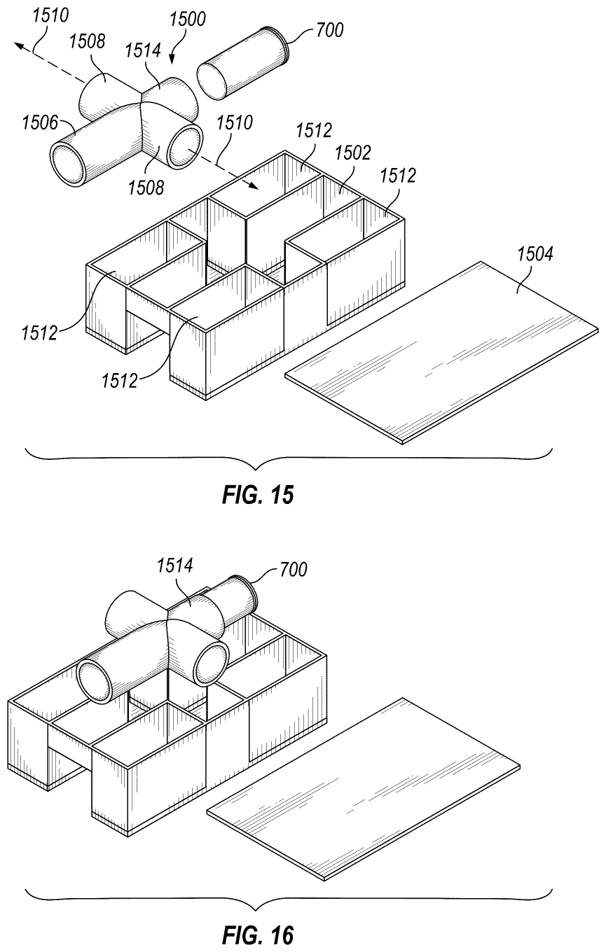

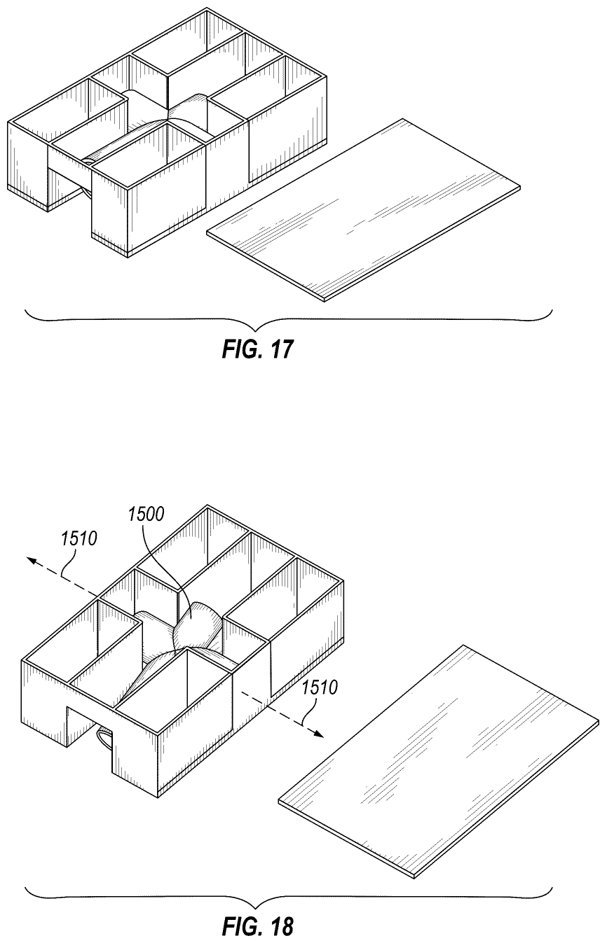

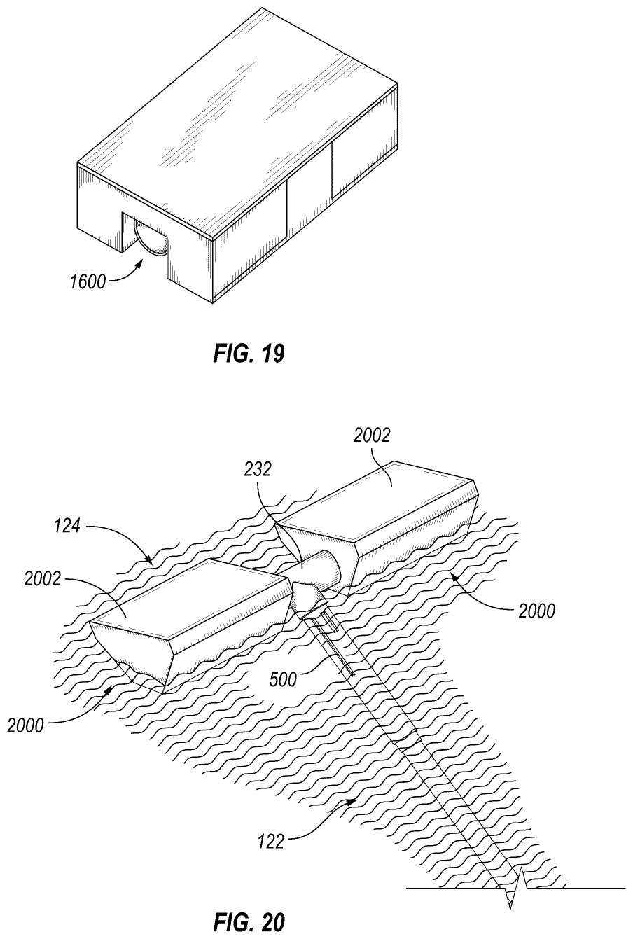

FIG. 15-19 illustrates an embodiment of skimmer 124. FIG. 15 illustrates an exploded view of skimmer 124. As illustrated, skimmer 124 may comprise a cross pipe 1500, a floc injector 700, a float body 1502, and a covering 1504. Cross pipe 1500 may be made of a tubular structure. However, the shape of cross pipe 1500 may be of any suitable shape. As illustrated cross pipe 1500 may comprise a lower outlet 1506 that may connect to downtube 122. Additionally, cross pipe 1500 may comprise connector pipe 1508 that may connect to float body 1502, which may allow cross pipe 1500 to pivot along longitudinal axis 1510. Connector pipe 1508 may connect to float body 1502 by any suitable means as long as the connector means allow connector pipe 1508 to rotate about longitudinal axis 1510. Float body 1502 of skimmer 124 may further comprise buoyancy compartments 1512. Buoyancy compartments 1512 may be any size and/or shape in which air or a floatation material (not illustrated) may be contained. Buoyancy compartments 1512 may be used to store chemical flocculant, batteries, solar panel cabling, computer processors, metering equipment or other materials and equipment required for floc injector 700. The material or air may allow skimmer 124 to float upon surface layer 112. As discussed above, as skimmer 124 floats upon the surface of water and may act as a point on entry for fluid 104 to pass through downtube 122 through hinge valve 900 (e.g., referring to FIG. 9) and out fluid outlet 116 (e.g., referring to FIG. 1) at a controlled rate of fluid flow. It should be noted that the controlled rate of fluid flow may be variable and depend on the orientation of orifice plate 216 or hinge valve 900, skimmer 124, and downtube 122 as discussed above. FIG. 16 illustrates that floc injector 700 may be disposed in entrance 1514. Floc injector 700 may operate and function according to the methods and systems described above. FIG. 17 illustrates cross pipe 1500 disposed within skimmer 124, according to the methods and systems described above. FIG. 18 illustrates an example in which skimmer 124 may be floating at an elevated position above variable flow apparatus 120 (such as hinge valve 900). In this example, and noted above, cross pipe 1500 may rotate about the longitudinal axis 1510. This rotation may allow skimmer 124 to float in a balanced manner on surface layer 112. FIG. 19 illustrates a perspective top view of skimmer 124. Skimmer 124 may have a cutout 1600 in which downtube 122 may connect to cross pipe 1500.

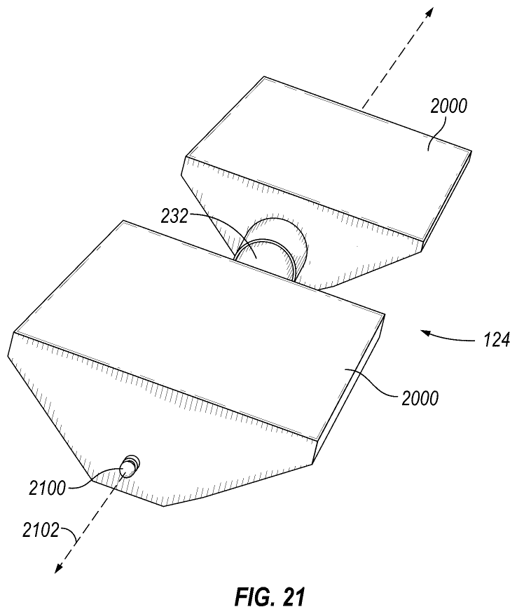

FIGS. 20 and 21 further illustrate an example in which skimmer 124 may float on surface layer 112 using buoyant material 2000. As illustrated, buoyant material 2000 may be disposed on any side of skimmer 124. In examples, buoyant material may comprise a plurality of pieces and there may be any number of buoyant materials attached to skimmer 124. Buoyant material 2000 may be any shape, such as triangular in nature as illustrated, circular, or any polynomial shape. Generally buoyant material 2000 may be wood, cork, natural fibers such as hemp and flax, polyethylene, polypropylene, closed-cell foam, syntactic foam, polyurethan foam, rubber, inflatable bladders, aerogel, fiberglass, carbon fiber, aluminum, bioplastics, and/or the like. Further, buoyant material 2000 may be covered, at least in part, with a coating 2002 to increase buoyance, which may also provide resistance to saturation of buoyant material 2000. Coatings 2002 may comprise hydrophobic Coatings, silicone-based coatings, fluoropolymer coatings such as Teflon, nano-coatings such as silica-based or hydrophobic nanocomposites, superhydrophobic, wax coatings, polyurethane coatings, epoxy resins, acrylic coatings, zinc-rich primers, epoxy coatings, inflatable material coatings, PVC coatings with plasticizers, and/or butyl rubber coatings. FIG. 20 further shows downtube 122 with one or more apertures 500 as discussed above in FIG. 5. In examples, buoyant material 2000 may be semi pervious to fluid 104, which may allow fluid 104 to pass through buoyant material 2000 and into inlet arms 232.

FIG. 21 illustrates a side view of skimmer 124 in which a rod 2100 may run through each buoyant material 2000 and through inlet arm 232. This may hold buoyant material 2000 to skimmer 124 and may allow buoyant material 2000 to pivot along longitudinal axis 2102. Rod 2100 may be held in place by nuts, bolts, washer, and/or the like. In other examples, friction between buoyant material 2000 and rod 2100 may hold rod 2100 in place.

Regulations for sizing sediment and detention basins and ponds typically require a max volume that may only be achieved infrequently, such as statistically every 2 years. While longer impoundment time may be favorable to increase sediment capture, regulations also typically require the basin to be drained in a maximum allotted time, such as max 72 hours, to drain and prepare the basin or pond for the next rain event. Current “skimmer” products are typically designed specifically to drain the max volume storm event in the maximum allowable time. The orifice size and position are nearly constant, and therefore the discharge is nearly constant, regardless of the volume or elevation in the basin. Thus, current skimmer products may discharge higher flow rates from the basin or pond from smaller, more frequent storm events. This may increase velocity and turbidity in the basin resulting in more suspended solids and unnecessary discharge of sediment. By varying the orifice size and/or varying the head pressure, each related to basin depth, the flow in the present invention can be engineered to restrict flows in smaller storms and increase flow in larger storms to enhance sediment capture. Also, by delaying the use of flow by use of a siphon, peak flows can be further reserved for the largest basin volumes and elevations. Further, by introducing flocculant into the turbid water via the invention can increase capture of smaller particles, improve turbidity, and better protect properties and waterways.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. It is also to be understood that the terminology used herein is for the purpose of describing particular embodiments only and is not intended to be limiting. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected. If there is any conflict in the usages of a word or term in this specification and one or more patent or other documents that may be incorporated herein by reference, the definitions that are consistent with this specification should be adopted for the purposes of understanding this invention.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

What is claimed is:

1. A fluid removal device, comprising:
a variable flow apparatus,
a downtube connect to the variable flow apparatus at a first end; and
a skimmer connected to a second end of the downtube opposite the first end.

2. The fluid removal device of claim 1, further comprising a fluid outlet connected to the variable flow apparatus.

3. The fluid removal device of claim 1, further comprising a relief pipe connected to the variable flow apparatus.

4. The fluid removal device of claim 3, further comprising a fluid outlet connected to the relief pipe.

5. The fluid removal device of claim 1, further comprising a floc injector.

6. The fluid removal device of claim 5, wherein the floc injector is disposed within the downtube.

7. The fluid removal device of claim 5, wherein the floc injector is disposed within the skimmer.

8. The fluid removal device of claim 5, wherein the floc injector is disposed outside the downtube.

9. The fluid removal device of claim 5, wherein the floc injector is disposed outside the skimmer.

10. The fluid removal device of claim 1, further comprising one or more apertures disposed within the downtube.

11. The fluid removal device of claim 1, wherein at least a portion of the downtube is flexible.

12. The fluid removal device of claim 1, wherein the downtube comprises two or more pieces and at least one piece is flexible.

13. The fluid removal device of claim 1, wherein the skimmer comprises at least one inlet arm.

14. The fluid removal device of claim 13, further comprising flotation material disposed in the at least one inlet arm.

15. The fluid removal device of claim 1, wherein the variable flow apparatus is a hinge valve.

16. The fluid removal device of claim 15, wherein the hinge valve comprises a container.

17. The fluid removal device of claim 16, wherein the container further comprises a fluid outlet and a slot, wherein a variable flow plate is disposed the slot.

18. The fluid removal device of claim 17, wherein a channel connects the fluid outlet and the slot.

19. The fluid removal device of claim 16, further comprising an opening in which a variable flow plate may be disposed.

20. The fluid removal device of claim 16, further comprising an outer rotation structure that rotates about a longitudinal axis of the container.
